(19) United States
(12) Patent Application Publication
(10) Pub. No.: US 2014/0187698 A1
(43) Pub. Date: Jul. 3, 2014

(54) BINDER MIXTURE FOR PRODUCING MOULDED PARTS USING INJECTION METHODS

(71) Applicants: Vladislav Kruzhanov, Remscheid (DE); Nicola De Cristofaro, Remscheid (DE)

(72) Inventors: Vladislav Kruzhanov, Remscheid (DE); Nicola De Cristofaro, Remscheid (DE)

(21) Appl. No.: 14/167,327

(22) Filed: Jan. 29, 2014

Related U.S. Application Data
(63) Continuation of application No. PCT/EP2011/003865, filed on Aug. 2, 2011.

(30) Foreign Application Priority Data
Aug. 2, 2011 (EP) PCT/EP2011/003865

(51) Int. Cl. C08L 23/12; C08L 31/04; C08K 5/01; C08K 5/09

(52) U.S. Cl. CPC C08L 23/12; C08K 5/09; C08L 31/04; C08K 5/01
USPC 524/322; 524/524

(57) ABSTRACT

A binder mixture with an expanded application range has at least one polymer compound A, selected from a group comprising polyolefins, in a range of approximately 10 wt. % to approximately 60 wt. % of the total quantity of binder mixture, with a first softening range and a first melt viscosity; at least one polymer compound B in a quantity of approximately 10 wt. % to approximately 65 wt. % of the total quantity of binder mixture, with a second softening range and a second melt viscosity; and at least one non-polymer compound C in a quantity of approximately 10 wt. % to approximately 65 wt. % of the total quantity of binder mixture. The first and second softening ranges and melt viscosities have certain characteristics and compound C can be dissolved in certain solvents within a certain temperature range.

### CROSS-REFERENCE TO RELATED APPLICATIONS

This application is a Continuation Application of PCT International Patent Application No. PCT/EP2011/003865, filed Aug. 2, 2011, the disclosure of which is hereby incorporated by reference as if set forth in its entirety.

The present invention relates to a binder mixture for producing molded parts by means of an injection method, as well as to an injectable mixture (also called a feedstock), preferably comprising at least one binder mixture according to the invention and in addition thereto at least one pulverulent material selected from a group comprising metallic and/or ceramic materials, and moreover to a method for producing molded parts by means of injection molding.

One known method of injection is powder injection molding (PIM), which ultimately is a combination of the known injection molding of plastics for producing molded parts and sintering technology for producing pressed solids. The PIM method comprises mixing a metallic and/or ceramic powder with a binder, and subsequently processing this mixture in conventional injection apparatuses which are used also for producing plastic molded parts.

The molded part thus obtained is referred to as a “green compact”, which is later released and sintered, wherein further treatment steps after the sintering are also possible, such as thermal annealing, coating, and the like. The major advantage of the PIM method is the provision of near net shape sintered molded parts such that subsequent treatment steps can be simplified or can even possibly be dispensed with The binder calls for specific requirements for the purpose of ensuring not only adequate strength of the green compact but also adequate flowability, and thereby processability, in the mixture. A disadvantage of the known binders is often in ultimately imparting only a certain extent of flowability to the mixture with a metallic and/or ceramic powder, which is to be processed in the PIM method, in such a manner as to limit both the geometry, in particular with respect to undercuts, and the weight and size or length of the components produced by means of this method.

The invention solves the objective through a binder mixture comprising: at least one polymer compound A selected from a group comprising at least polyethylenes, including HDPE, LDPE, MDPE, and UHMW-HDPE, and/or at least a polypropylene, in an amount in a range from about 10 wt % to about 60 wt %, preferably about 21 wt % to about 45 wt %, based on the total amount of the binder mixture, having a first softening range measured according to DIN ISO 4625 and a first melt viscosity measured according to DIN 54811; at least one polymer compound B selected a group comprising at least a polyvinyl acetate in an amount from about 10 wt % to about 65 wt %, preferably about 20 wt % to about 45 wt %, based on the total amount from the binder mixture, having a second softening range measured according to DIN ISO 4625 and a second melt viscosity measured according to DIN 54811; and at least one non-polymer compound C selected from a group comprising at least a natural, synthetic, and/or chemically modified wax, in particular paraffin wax, including hard paraffin, micro-wax, montan wax, ceresin, ozokerite, and/or montan ester wax, in an amount from about 10 wt % to about 65 wt %, preferably about 15 wt % to about 58 wt %, based on the total amount of the binder mixture; wherein the first softening range of the compound A and the second softening range of the compound B are between about 80° C. and about 200° C., preferably in a range between 100° C. to about 180° C., even more preferably in a range between about 130° C. and 175° C.; wherein the ratio of the second melt viscosity of the compound B to the first melt viscosity of the compound A amounts to about 0.1:1 to about 100:1, preferably 0.15:1 to 15:1, even more preferably 0.2:1 to 1.95:1; and the compound B and the compound C are solvable in a solvent selected from a group comprising acetone, xylene, turpentine, tetrahydrofuran and/or ethyl acetate, at a temperature in a range of about 20° C. to about 90° C., preferably about 30° C. to about 85° C., even more preferably about 35° C. to about 70° C.

Insofar as the term “about” is stated above or below in connection with information pertaining to ranges of physical and/or chemical parameters, in this context, it will be readily apparent to a person skilled in the art, by virtue of being expert in the fields of powder metallurgy and injection methods, that that the ranges slightly above or below are not excluded by these specified range limits, but rather also contribute to the fulfillment of the objective solved by the present invention. Thus, a person skilled in the art would still readily take into account deviations of ±/−10% from the specified range limits for attaining the objective of the present invention and in reworking the teachings of the invention.

The term “soluble” or “solubility” for the purposes of the present invention, when concerning those compounds in connection to which the term “solvable” is used in the present invention, i.e., in particular the compounds B, C, and D, is understood to be based on a temperature range of about 20° C. to about 90° C., preferably about 45° C. to about 80° C., for a dissolution time in a range of about eight hours to about 36 hours, depending on the wall thickness, wherein green compacts produced by means of using the binder of the invention are completely set in the provided solvent. With the aforementioned conditions, preferably at least about 90 wt %, even more preferably at least about 95 wt % of the compounds in question, in particular the compounds B, C, and D, are released from the green compact/molded part.

Any usage of the term “melt viscosity” used in the present invention is in reference to a value that depends on the chemical nature of the polymer and on the temperature. Information regarding the melt flow rate (MFR) or melt volume rate (MVR) (melt indices), which are determined according to DIN EN ISO 1133 under specific conditions, is typically provided for the compounds included in the binder mixture according to the invention. Knowledge of these conditions makes it possible to convert these MFR and MVR values into the dynamic viscosity [Pa·S] of the melt (melt viscosity). Also, the MFR and MVR values relate to specific temperatures (for example, 190° C. or 230°C.). Viscosity values at injection molding temperatures are of interest for the binder mixture according to the invention. Such values must be explicitly established. The viscosity values for the melt viscosity of the individual polymers of the present invention have been measured with the aid of a capillary rheometer, the “Rheo-Tester 1000” by GÖTTFERT Werkstoff-Prilfmaschinen GmbH (Germany) according to DIN 54811.

Insofar as a ratio of the first and second melt viscosities of the compounds A and B is discussed for the purposes of the present invention, the pertinent information preferably refers to a temperature of the injection process, which for such binder mixtures lies in a range of about 160° C. to about 180° C.

The softening range of the compounds A and B is determined according to DIN ISO 4625 (with a ring and ball).

Insofar as the terms “polymer” or “polymer compound” are used in the present invention, pursuant to the IUPAC definition, they are to be understood hereinafter to be a substance that is composed of such molecules in which one or a plurality of types of atoms or atom groupings are repeatedly connected to one another. For the purposes of the present invention, the terms “polymer compound” or “polymers” in particular are to be understood to be such compounds as are formed as homopolymers, copolymers, block polymers, block copolymers, graft polymers, and/or isotactic polymers or mixtures thereof. Accordingly, those compounds that are not subject to the above definition are referred to as “ non-polymer compounds” as defined for the purposes of the present invention.

For the sake of clarity, it should be stated that for the purposes of the present invention, the term “compound” as used in connection with the compounds A, B, C, and D may relate to a single substance as well as to a mixture of substances.

The major advantage of the binder mixture according to the invention resides in possessing an excellent flowability even with a favorable green strength, such that even large-sized components, in particular highly elongated ones, and even those with undercuts, can be produced. With an appropriate interpretation of the binder mixture of the invention, same can moreover be at least partially dissolved in a solvent so as to be gentler with respect to the operating and environmental aspects in comparison to a catalytic debinding process (for example, with HNO₃). In particular, it is advantageously possible also to obtain green compacts that have substantially no burr formation, thereby further facilitating additional treatments, in particular processing, of the green compacts. Moreover, the molded parts provided by means of the binder mixture according to the invention possess only a slight, preferably substantially no, tendency to form cracks, even with large and in particular elongated molded pieces, and thereby possess an adequate shape stability for the subsequent sintering.

The binder mixture according to the invention includes the at least one polymer compound A preferably in an amount from about 21 wt % to about 45 wt %, preferably to about 40 wt %, more preferably in an amount from about 30 wt % to about 38 wt %, based on the total amount of the binder mixture. The binder mixture according to the invention includes the at least one polymer compound B, preferably in an amount from about 20 wt % to about 45 wt %, more preferably in an amount from about 24 wt % to about 38 wt %, based on the total amount of the binder mixture. The binder mixture according to the invention includes the at least one non-polymer compound C preferably in an mount from about 15 wt % to about 58 wt %, more preferably about 20 wt % to about 38 wt %, yet even more preferably in an amount from about 25 wt % to about 35 wt %, based on the total amount of the binder mixture.

The ratio of the second melt viscosity of the compound B to the first melt viscosity of the compound A amounts preferably to about 0.25:1 to about 1.9:1 and may also amount to about 2:1 to about 100:1, preferably about 3:1 to about 50:1, even more preferably about 5:1 to about 40:1. More preferably, the compound A is not soluble in a solvent of a group comprising acetone, xylene, turpentine, tetrahydrofuran, and/or ethyl acetate, in which the compound B and the compound C are at least predominantly soluble in a temperature range from about 20° C. to about 90° C. Advantageously, the melt viscosities of the compound A and the compound B differ from one another by about 0% to about 15%.

The compound B is selected from a group comprising at least one polyvinyl acetate, more preferably consisting of at least one polyvinyl acetate homopolymer, even more preferably consisting of at least one polyvinyl acetate having a molecular weight M_{w}, as established in accordance with the method of testing according to SEC, PS-Standard, in a range between about 150,000 and about 500,000, even more preferably between about 200,000 and about 400,000. For the purposes of the present invention, it is also possible to use copolymers of vinyl acetate, for example, ethylene/vinyl acetate copolymers or copolymers with vinyl chloride, such as VCEVA or VCVAC. Particularly preferable, however, urea polyvinyl acetate or mixtures of different polyvinyl acetates, because it has surprisingly been found that, on account of having similar melt ranges and a higher viscosity compared to the compound A, so doing is ideal in providing both an adequate flowability and strength to the mixtures or molded parts produced by using the binder according to the invention at simultaneously a similar solubility to that of the compound C.

Advantageously, the melt viscosity of the compound B, which is preferably selected from a group comprising polyvinyl acetates, lies in a range from about 200 Pa·s to about 100,000 Pa·s, even more advantageously in a range from about 1,500 Pa·s to about 20,000 Pa·s, in each case at 160° C., and the softening range being between about 140° C. and about 195° C.

The compound A is selected from a group comprising at least one polyethylene, inclusive of HDPE, LIVE, MDPE, and/or UHMW-HDPE, and/or at least one polypropylene, and is preferably selected from a group comprising a polypropylene or mixtures of polypropylenes, more preferably consisting of at least one polypropylene homopolymer. Advantageously, the first melt viscosity of the compound A is in a range from about 100 Pa·s to about 10,000 Pa·s, even more preferably in a range from about 1,000 Pa·s to about 5,000 Pa·s, in each case at 160° C. Advantageously, the first softening range of the compound A lies between about 150° C. and about 180° C.

Even more advantageously, the density of the compound A lies in a range from about 0.85 g/cm² to about 0.95 g/cm2, especially advantageously in a range from about 0.88 g/cm² to about 0.93 g/cm², at 20° C., as established according to DIN EN ISO 1183. Advantageously, the density of the compound B lies in a range from about 1.1 g/cm ² to about 1.25 g/cm², even more advantageously in a range from about 1.15 g/cm² to about 1.2 g/cm², at 20° C. according to DIN EN ISO 1183.

The mean molecular weight M_{w} according to the SEC, PS-Standard lies advantageously in a range from about 200,000 to about 1,000,00, preferably in a range from 250,000 to about 800,000, for the compound A.

The non-polymer compound C is selected from a group comprising natural, synthetic, and/or chemically modified waxes, in particular paraffin waxes, inclusive of hard paraffin, microwax, montan wax, ceresin, ozokerite, and/or montan ester waxes. It is herein preferable for the compound C to be selected from a group comprising a hard paraffin or mixtures of hard paraffins. The compound C preferably has a solidification point between about 40° C. and 90° C., even more preferably between about 50° C. and about 65° C., as measured according to DIN ISO 2207. The melt viscosity of the compound C lies preferably in a range from about 0.5 to about 10 mPa·s at 100° C.

Advantageously, the density of the compounds A, B, and/or C lies in a range from about 0.8 g/cm² to about 1.5 g/cm²at 20° C., preferably about 0.85 g/cm³ to about 1.3 g/cm³ up to 20° C., as measured according to DIN EN ISO 1183.

Even more advantageously, the binder mixture according to the invention comprises at least one compound D selected from a group comprising at least one fatty acid and/or fatty acid ester. Even more preferably, the compound D is selected from a group comprising at least one fatty acid, yet even more preferably from a group comprising stearic acid and/or oleic acid. Even more preferably, the binder according to the invention comprises the compound D in an amount to about 8 wt %, based on the total amount of the binder mixture, even more preferably in an amount from 0.5 wt % to about 6 wt %, yet even more preferably in an amount from about 0.8 wt % to about 2.8 wt %, in each case based on the total amount of the binder mixture. The melting point of the compound D lies advantageously in a range from about 50° C. to about 75° C., even more preferably in a range from about 58° C. to about 69° C.

In a particularly preferred embodiment, the binder material according to the invention is composed of the compounds A, B, C, and optionally D, wherein the compound A is a polypropylene, the compound B is a polyvinyl acetate, the compound C is a hard paraffin, and the optionally but preferably present compound D is stearic acid. Particularly preferable is a binder mixture which comprises about 30 wt % to about 38 wt % of at least one polyvinyl acetate, about 25 wt % to about 38 wt % of at least one hard paraffin, about 30 wt % to about 40 wt % of at least one polypropylene, and optionally about 0.3 wt %, preferably about 0.5 wt % to about 2.6 wt %, of stearic acid, in each case based on the total amount of the binder mixture. Advantageously, the binder mixture does not contain any additional compounds beyond the above-mentioned compounds A, B, C, and optionally D. The invention may provide that the compound D is not included in the above-mentioned preferred binder mixture.

The present invention additionally relates to an injectable mixture (feedstock) comprising a binder mixture according to the invention, even more preferably further comprising at least one pulverulent material. The pulverulent material is preferably selected from a group comprising at least one metallic and/or ceramic material. Even more preferably, the injectable mixture comprises in particular a binder material according to the invention that can be used in a PIM method, in an amount in a range from about 30 vol % to about 60 vol %, based on the total volume of the injectable mixture, and a pulverulent material selected from a group comprising metallic and/or ceramic materials (for example, 17-4PH, 316L, Fe8Ni, Al₂O3Al₂O₃, ALN and/or Si₃N₄) in an amount from about 40 vol % to about 70 vol %, based on the total volume of the injectable mixture. The injectable mixture according to the invention comprises the binder mixture according to the invention preferably in an amount in a range of up to about 10 wt %, preferably in an amount from about 5 wt % to about 9 wt %, in each case based on the total amount of the injectable mixture.

The present invention moreover relates to a method for producing molded parts by means of an injection method, advantageously by means of powder injection molding (PIM), wherein an injectable mixture, as described above, is fed as a feedstock to an injection device to produce a molded part is produced, which is then: treated with a solvent for debinding the soluble components of the binder mixture, preferably at a temperature in a range from about 45° C. to about 80° C. and preferably over a period of time from about eight hours to about 36 hours; subjected to a thermal treatment, in particular over a period of time of about one hour to about ten hours for further debinding, particular in a temperature range from about 300° C. to about 650° C.; and sintered, in particular at a temperature in a range from about 1000° C. to about 1400° C., preferably about 1200° C. to about 1380° C.

In the present invention, the term “solvent” is understood to refer to a single such agent or to a mixture of such agents. The solvent is herein preferably selected from a group comprising acetone, xylene, turpentine, tetrahydrofuran, and/or ethyl acetate.

Advantageously, the compounds B and C and optionally also D are completely removed from the green compact in the debinding by means of the solvent. In particular, a residual amount of the compound B, preferably in an amount from not less than about 1 wt %, based on the total amount of the injectable mixture i.e., a mixture of at least one binder mixture and at least one pulverulent material, present in the molded part before the thermal treatment, can be removed in the thermal treatment, which may be merged into a pre-sintering, as can the compound A. The compound D can preferably be removed by a debinding by means of a solvent.

These and other advantages shall be further described in the following examples. It should first be noted here that the features invoked in the following examples do not limit the scope of the present invention. Rather, the features respectively stated in the general description, including the examples, can be combined with one another for further enhancement. In particular, neither a limitation of the specifically selected compounds A, B, C, and D, nor a limitation of the specific parameters of the PIM method, is provided for or intended; on the contrary, other materials, compositions, or injection methods can be used.

Altogether four example mixtures of a binder according to the invention were produced, with a variety of components for the compounds A, B, and C, and optionally D.

As compound Au polypropylene homopolymer from BaseII Polyolefins GmbH (Köln) was used, having a softening range of about 150° C. to about 170° C., as established according to DIN ISO 4625 (with a ring and ball), a density at 20° C. in a range from about 0.89 g/cm² to about 0.91 g/cm² according to DIN EN ISO 1183, and a melt viscosity of about 2,000 Pa·s at 160° C. and about 2,500 Pa·s at 180° C., as measured according to DIN 54811.

As compound B a polyvinyl acetate homopolymer from Wacker Chemie AG was used, having a melt viscosity at 160° C. of about 2,000 Pa·s, a mean molecular weight M_{w} in a range from about 270,000 to about 310,000, and a density of about 1.18 g/cm² according to DIN EN ISO 1183, as well as a softening range of about 150° C. to about 160° C., as measured according to DIN ISO 4625 (with a ring and ball).

As compound C a hard paraffin from H&R Wachs Company (Hamburg) was used, having a melt viscosity from about 4 mPa·s at 100° C. according to DIN 54811, a solidification point of about 61° C. according to DIN ISO 2207, and a density of about 0.775 g/cm² at 80° C. according to DIN 51757.

As compound D a stearic acid obtained from Fisher Scientific GmbH (Schwerte) was used, having a density of about 0.94 g/cm² at 20° C. according to DIN EN ISO 1183 and a melting point of about 67° C. to about 69° C.

The above-mentioned compounds A, B, C, and optionally D were first mixed with one another into mixtures 1 to 4, and next mixed with a metallic powder at 180° C. to obtain a homogenous mixture before being supplied to an injection device. The metallic powder used herein was one designated as Carb.Fe (carbonyl iron) by Sintez Engineering Ltd. (Dzerzhinsk, Russia), a powder 316L, and 17-4PH from Carpenter Powder Products GmbH (Düsseldorf). Also, a mixture of the master alloy powder 17-4PH MA with carbonyl/iron at a ratio of 2:1 was used in order to subsequently achieve a composition of 17-4PH in the material.

The powder injection molding of the feedstock (injectable mixtures) thus produced was carried out with an injection device from the company Arburg GmbH & Co. KG (Loβburg), to manufacture green compacts in the form of spirals with the dimensions 740:5:3 (length:width:height, in mm) or components with the dimensions (197 mm long, 30 mm wide, and 34 mm high, and with wall thicknesses up to 10 mm) at a weight of 400 g. The cylinder and mold temperatures, the injection pressures, the injection speeds, the holding pressures, and the cooling times are as shown in the following table.

Subsequently to the production of the green compacts by means of the powder injection molding, the resulting green compacts were debinded in ethyl acetate in a temperature range between 45° C. and 80° C., wherein the compounds B, C, and D were substantially completely removed from the green compact, to a very low residual amount of the compound B. The debinding by means of a solvent herein took place over eight to 36 hours in a debinding system of LÖMI GmbH (Aschaffenburg), preferably 12 to 24 hours. Subsequently, the molded parts, thus pre-debinded, were subjected to a thermal treatment at a temperature of about 600° C. over a period of about one to ten hours, preferably one to four hours, wherein the compound A and the slight residual amount of the compound B were entirely debinded from the molded part, which thermal treatment was joined by a sintering at a temperature in a range from about 1200° C. to about 1380° C. over a time of one to about four hours.

The following table sets forth the compositions of the total four mixtures, as well as the respective injection parameters and the properties of the resulting green compacts or molded parts after sintering.

| | TABLE | | | |
|---|---|---|---|---|
| | Mixture | | | |
| | 1 | 2 | 3 | 4 |
| Metal powder | Carb.Fe | 316L | 17-4PH | 17-4PH |
| | | | | MA + Carb. |
| | | | | Fe |
| Wt % of binder | 7.3% | 7.0% | 6.9% | 7.0% |
| Wt % of powder | 92.7% | 93.0% | 93.1% | 93.0% |
| Vol % of powder | 62.0% | 62.0% | 62.0% | 62.5% |
| Binder | | | | |
| A [wt %] | 42.5 | 28.0 | 22.0 | 38.0 |
| B [wt %] | 38.5 | 28.0 | 22.0 | 26.0 |
| C [wt %] | 16.5 | 44.0 | 56.0 | 35.0 |
| D [wt %] | 2.5 | 0 | 0 | 1.0 |
| injection molding | | | | |
| parameters | | | | |
| Cylinder | 170-195 | 175-195 | 175-195 | 175-190 |
| temperature/° C. | | | | |
| Molding | 60 | 58 | 55 | 50 |
| temperature/° C. | | | | |
| injection pressure/ | 2000 | 1350 | 1350 | 1350 |
| bar | | | | |
| injection speed/ | 40 | 65 | 60 | 65 |
| ccm/s | | | | |
| Holding pressure/ | 1500 | 800 | 1000 | 600 |
| bar | | | | |
| Cooling time/s | 25 | 35 | 60 | 30 |
| Properties | | | | |
| Flowability | Adequate | Satisfactory | Very | Very |
| | | | favorable | favorable |
| Green strength | Very | Satisfactory | Adequate | Favorable |
| | favorable | | | |
| Demoldability | Favorable | Satisfactory | Favorable | Favorable |
| Finish quality | Favorable | Satisfactory | Satisfactory | Adequate |

The variation of the compounds A to D makes it possible to conceive of different feedstocks that have the properties best suited to a specific application. For example, the mixtures 3 and 4 reached very favorable flow properties. The mixture 1 obtained very favorable green strength and shape stability of the unsintered molded part. The mixture 2 offers a compromise in the important properties.

The present invention thus provides a binder mixture and feedstock which can be used in particular in the PIM method to produce components of larger constructions, in particular with a large wall thickness/length ratio.

1. A binder mixture for producing molded parts by means of an injection method, the binder mixture comprising: at least one polymer compound A, selected from a group comprising polyolefins in an amount in a range of about 10 wt % to about 60 wt %, based on the total amount of the binder mixture, having a first softening range and a first melt viscosity; at least one polymer compound B, in an amount from about 10 wt % to about 65 wt %, based on the total amount of the binder mixture, having a second softening range and a second melt viscosity; and at least one non-polymer compound C in an amount from about 10 wt % to about 65 wt %, based on the total amount from the binder mixture; wherein the first softening range of the compound A and the second softening range of the compound B are between about 80° C. and about 200° C.; the ratio of the second melt viscosity of the compound B to the first melt viscosity of the compound A amounts to about 0.1:1 to about 100:1; and the compound B and the compound C are solvable in a solvent selected from a group comprising acetone, xylene, turpentine, tetrahydrofuran and/or ethyl acetate, at a temperature in a range of about 20° C. to about 90° C.

2. The binder mixture as set forth in claim 1, characterized in that the compound B is selected from a group comprising at least one polyvinyl acetate.

3. The binder mixture as set forth in any of the preceding claims, characterized in that the second melt viscosity of the compound B lies in a range from about 200 Pa·s to about 100,000 Pa·s at 160° C.

4. The binder mixture as set forth in claim 1, characterized in that the compound A is selected from a group comprising at least one polyethylene, inclusive of HDPE, LDPE, MDPE, and UHMW-HDPE, and/or at least one polypropylene.

5. The binder mixture as set forth in claim 1, characterized in that the first melt viscosity of the compound A lies in a range of about 100 Pa·s to about 10,000 Pa·s at 160° C.

6. The binder mixture as set forth in claim 1, characterized in that the compound C is selected from a group comprising at least one natural, synthetic, and/or Chemically modified wax, in particular paraffin wax, inclusive of hard paraffin, microwax, montan wax, ceresin, ozokerite, and/or montan ester wax.

7. The binder mixture as set forth in claim 1, characterized in that a solidification point of the compound C lies between about 40° C. and about 90° C.

8. The binder mixture as set forth in claim 1, wherein a density of the compounds A, B, and/or C lies in a range from about 0.8 g/cm³ to about 1.5 g/cm³ at 20° C.

9. The binder mixture as set forth in claim 1, wherein further including at least one compound D, selected from a group comprising at least one fatty acid and/or fatty acid ester.

10. The binder mixture as set forth in claim 9, wherein by comprising the compound D in an amount from about 0.05 wt % to about 8 wt %, based on the total amount of the hinder mixture.

11. The binder mixture as set forth in claim 1, wherein the compound A is a polypropylene, the compound B is a polyvinyl acetate, the compound C is a hard paraffin, and the optionally present compound D is stearic acid.
